(19) United States
(12) Patent Application Publication
(10) Pub. No.: US 2025/0102096 A1
(43) Pub. Date: Mar. 27, 2025

(54) Compensation element, method and system for the active damping of a medium

(71) Applicant: INTEGRATED DYNAMICS ENGINEERING GMBH, Raunheim (DE)

(72) Inventors: Johannes HARTGERS, Opheusden (NL); Robert VEHOF, Deventer (NL)

(21) Appl. No.: 18/729,974

(22) PCT Filed: Jan. 12, 2023
(86) PCT No.: PCT/EP2023/050609

§ 371 Date: Jul. 18, 2024

(30) Foreign Application Priority Data
Jan. 21, 2022 (DE) 10 2022 101 448.7

(51) Int. Cl. F16L 55/045

(52) U.S. Cl. CPC F16L 55/045

(57) ABSTRACT

The disclosure relates to a compensation element for actively damping vibrations of a medium, in particular a fluid. The compensation element comprises a hollow body having an internal volume, with a compensation volume being formed in the internal volume, with the hollow body also having at least two openings which connect the compensation volume to a fluid conduit that is used to supply and discharge the medium, wherein the compensation element is separable from the fluid conduit in a non-destructive manner, and at least one actuator which can increase or decrease the compensation volume during operation.

The present disclosure generally relates to a compensation element and to a method and a system for actively damping vibrations of a medium, in particular a fluid. The compensation element allows, for example, to compensate for pressure fluctuations in piping systems.

The transmission of vibrations through media, especially fluids, has been a problem for a long time. Especially with incompressible liquids, there is only little damping of vibrations as they propagate, so that they can spread far and wide. This applies, for example, to liquid-filled piping systems to which sensitive machines and systems are connected and which place correspondingly high demands on a constant pressure in the piping system. Various solutions have been developed to reduce possible pressure fluctuations.

For example, expansion vessels are known to be virtually flexible compensators which make it possible to expand the pipe volume in closed piping systems when the pressure increases and, conversely, to reduce the pipe volume when the pressure drops. However, this can contribute to the pressure downstream of this compensator or vessel becoming lower.

For certain applications, such as precision devices that place very high requirements on constant pressure conditions, it may be necessary to use relatively large volumes for the expansion vessels in order to effectively compensate for pressure changes. Pressure changes can lead to vibrations, in particular with incompressible fluids such as water, which are reflected many times in piping systems and can therefore be transferred over long distances. This can affect or even damage sensitive equipment, such as electron beam devices or sensors. Volume changes which can have an adverse effect on the connected devices or systems can also occur.

The pressure changes may also lead to deformation, which can cause further impairment or even damage.

Given this background, such solutions will more likely be used for applications where lower requirements apply. For example, such expansion vessels are used to maintain a constant pressure in a heating circuit or to prevent water hammer in the water circuit of a house. Usually, they are adapted to a specific frequency range.

Another solution involves using a combination of Helmholtz-like resonators in the flow to compensate for or at least reduce pressure fluctuations at different frequencies. The resonators are selected depending on the volume to be dampened and the pipe lengths in order to be able to adjust the frequency response.

DE 10 2013 217 119 A1 describes such a damping device for damping vibrations in a pressure line by way of the example of a motor vehicle clutch. A hollow cylindrical damper based on a Helmholtz resonator is proposed, which has a double-walled housing to form a damper volume. Such resonators are typically precisely tuned to a specific frequency field, which can then be effectively filtered. In the case of a larger frequency spectrum, the damper volume has to be increased.

DE 10 2011 081 538 A1 describes a hydraulic damping element, also by way of the example of a hydraulic system for actuating a clutch in the drive train of a motor vehicle. The damping element comprises a rotatably mounted damping mass which is set in rotation by a volume flow through the fluid line.

Such damping elements may be reliable, but they are quite complex in structure and are generally relatively large compared to the pipe diameter, for example. In addition, they have to be individually adapted to the volume and the piping system.

Other damping systems operate with an electro-rheological or magneto-rheological fluid, as is known from Applicant's patent specification EP 2 759 735 B1, for example.

The damping can be adjusted individually and continuously via a control loop. This is comparatively complex and can also be time-critical due to delayed response behavior.

It would therefore be desirable to have a compensation or damping element that does not exhibit these drawbacks.

The compensation or damping element should be as small as possible.

Furthermore, it may be desirable if the compensation or damping element would allow to be at least partially flexibly adapted to the specific characteristics of the volume and the piping system, so that it is not necessary to provide a special compensation or damping element for each volume or each piping system.

Simple installation on the intended piping system may also be desirable.

Furthermore, the compensation or damping element should also be employable together with a wide variety of media, in particular different fluids. These include, for example, media comprising ultra-pure water (UPW) such as can be used in the semiconductor industry and which is very corrosive, or other aggressive and/or corrosive media, and also liquids such as dielectric liquids, e.g. liquids with a high fluorine content.

The inventors have taken on this task.

This task is solved in a surprisingly simple manner by a compensation element for actively damping vibrations of a medium, in particular a fluid, as well as by a method and a system for actively damping vibrations of a medium, in particular a fluid, according to any one of the independent claims. Preferred embodiments and further refinements of the disclosure will be apparent from in the respective dependent claims.

Accordingly, the subject-matter of the disclosure is a compensation element for actively damping vibrations of a medium, comprising
a hollow body having an internal volume,
with a compensation volume being formed in the internal volume,
with the hollow body further having at least two openings which allow to connect
the compensation volume to the environment; and
at least one actuator which can increase or decrease the compensation volume during operation.

According to a preferred embodiment of the disclosure, the actuator may be arranged in the internal volume, but also outside thereof.

The medium can in particular comprise a fluid which may be in gaseous or liquid form. The compensation element may be used in conjunction with only slightly compressible or incompressible fluids, in particular liquids. This refers to fluids which, under normal pressure at 0.1 MPa and at a temperature of 10° C., have a compression modulus of at least 1.0·10⁹ Pa, preferably at least 1.5·10⁹ Pa, and particularly preferably at least 2.0·10⁹ Pa. Accordingly, fluids particularly suitable for the disclosure include oil, water, or oil-water mixtures.

In one embodiment of the disclosure, it is also intended to use demineralized water as a medium, i.e. to operate the compensation element in conjunction with purified and/or demineralized liquids. Demineralized water can be classified on the basis of conductivity, namely into purified low-salt water having a conductivity of 1-50 μS/cm (“purified water”), “pure water” having a conductivity of 0.1-1 μS/cm, and “ultra-pure water” having a conductivity of 0.055-0.1 μS/cm.

The disclosure is also particularly suitable for operation with purified, pure or ultrapure water (UPW) as is required and used in the semiconductor industry. In these liquids, other parameters and quantities may also be controlled and reduced, for example the total oxidizable carbon (TOC), particles, or dissolved gases. Accordingly, in one aspect, the disclosure also relates to a compensation element which is designed for use with low-salt water, pure water, and ultra-pure water.

In a further embodiment of the disclosure, it is also intended to use technical or dielectric fluids, in particular liquids, for example fluorine-containing fluids such as fluorine-containing liquids. More generally, the medium may comprise aggressive or corrosive liquids or gases.

The medium may, for example, be accommodated or carried in a piping system, a fluid conduit, a hydraulic line, a pressure line, or generally in any other suitable container or vessel.

For the sake of simplicity, the term “fluid conduit” will only be used below, although this is also intended to encompass a hydraulic line, a pressure line, a piping system, or generally any other container or vessel that is suitable for holding a medium, in particular a fluid. In the context of the disclosure, this fluid conduit is at least partially filled with the medium to be dampened, in particular the fluid, during operation.

In some embodiments, the hollow body may also be provided by the fluid conduit itself. In other words, the internal volume of a section of a fluid conduit may serve as a compensation volume.

The openings of the compensation element may be connected to the fluid conduit in a force-fitting and/or form-fitting manner. For this purpose, suitable connecting means or fittings can be provided to establish a force-fitting and/or form-fitting join between the fluid conduit and the openings. Desirably, these are selected so as to allow for simple assembly and, ideally, also non-destructive disassembly. This makes it easy to attach the compensation element and eliminates the need for weld seams, for example, which can also be desirable with regard to possible deformation or cracking. In the event of a possible defect, the compensation element can simply be exchanged and replaced.

According to a further embodiment of the disclosure, it is also possible and conceivable to connect the compensation element directly to an installation component or equipment that is to be cooled with water, for example, and/or is to be dampened. It will be appreciated that it is also possible to provide a plurality of compensation elements on an installation or equipment, for example in order to cool a larger surface or area.

The compensation elements installed in this way can be connected to the fluid conduit, and this is not only possible in linear configurations but also in network configurations. This also allows, for example, to cool larger areas as well.

The connections to the fluid conduit can also be established after the compensation element has been installed. Accordingly, in one aspect, the disclosure also relates to a compensation element which can be connected or is connected directly to an installation component or equipment. It will be appreciated that suitable fastening means can be provided on the compensation element for this purpose. The fastening may also be accomplished by adhesive bonding, for example. In other embodiments, however, it can also be desirable if the connection is designed to be separable in a non-destructive manner.

To actively dampen the vibrations, the compensation element can be firmly connected to the fluid conduit in a fluid-tight manner. Fluid-tight means that no medium or fluid escapes at the connection points between the compensation element and the fluid conduit during regular operation, i.e. under predefined pressure or temperature conditions.

The section of the fluid conduit that is subjected to the potential pressure fluctuations can be connected to a first opening of the hollow body. The second opening is also connected to a fluid conduit for this purpose.

The first opening will also be referred to as the inlet or inlet opening below, and the second opening as the outlet or outlet opening, while this distinction is made with regard to the functionality of the openings or the associated fluid conduits and not with regard to their technical design.

The second opening of the hollow body thus provides the outlet for the medium, which can enter the internal volume, in particular the compensation volume of the hollow body via the inlet. Pressure fluctuations in the fluid conduit on the inlet side can at least be mitigated or preferably compensated for by the compensation element. In other words, pressure fluctuations on the inlet side will be passed on to the outlet side only in reduced form or, ideally, not at all.

Pressure fluctuations are in particular understood to mean pressure surges or pressure differences that can arise due to a dynamic pressure change of a viscous medium in the fluid conduit. This may involve, for example, the pressure increase in a pipeline, which can occur when a shut-off valve is quickly closed or opened, or upon the start-up and shut-down of pumps in the fluid conduit. In certain cases, dynamic pressure changes are also referred to as pressure surges or water hammer.

The extent of a pressure surge varies and can depend on various factors, such as the volume of the fluid conduit or the compressibility of the medium. Generally, the extent of a pressure surge will be higher in liquid fluids, which are less compressible, than in gaseous media, and the mass inertia of the fluid also plays a role here.

Pressure changes are forwarded through pressure waves which will also be referred to as pressure fluctuations in the context of the disclosure. These are longitudinal waves. The deceleration or acceleration of a fluid in a fluid conduit requires a certain force which can be determined using Newton's second law. The pressure changes or pressure fluctuations can trigger vibrations or oscillations, in particular in the case of incompressible fluids such as water, which might affect the fluid conduit.

Vibrations can also be transmitted through the fluid conduit, even over rather long distances through the fluid conduit, so that damping may also be applied here.

For decoupling or dampening the vibrations in the fluid conduit or in the installation or even in individual fittings, it is also possible to use components such as rubber or rubber-like components, corrugated components, U-pipes or bellows, for example, provided the boundary conditions permit this.

Such vibrations in the fluid conduit can lead to several undesirable effects. For example, deformations and volume changes may cause changes in distances to an installation or equipment to be cooled, which can lead to stresses in the installation or equipment to be cooled. This can cause deformations in the area to be cooled.

Pressure surges can also cause damage to or in the affected systems. For example, sensitive devices such as electron beam apparatuses and also sensors can be affected or even damaged.

In the worst case, pipes can even burst or pipe holders can be damaged. The fittings connected to the fluid conduit, pumps, or even foundations can also be damaged by pressure surges. The problem is that minor damage is often not immediately visible, so consequential damage can occur.

Pressure surges or pressure fluctuations can be particularly critical in equipment, machines or installations that are highly sensitive, for example installations or equipment in the nanotechnology sector, or electron beam apparatuses which include highly sensitive optical devices, for example.

This applies, for example, to a water cooling circuit to which machines, installations or apparatuses of the semiconductor industry or semiconductor equipment are connected and which are highly sensitive to pressure fluctuations in the water cooling circuit or include sensitive parts. Here, pressure fluctuations in a range of well below 1 Pa, for example in ranges below 0.1 Pa or even below 0.01 Pa can lead to deviations that can disrupt or affect the processes, or the required accuracies can no longer be maintained and/or damage can occur.

Since water has a high compression modulus which is significantly higher than that of oil, for example, it is considered almost incompressible, so that pressure changes can spread quickly and with great force in the fluid conduit.

The compensation element according to the disclosure serves to reduce or compensate for pressure surges in fluid conduits, so that pressure fluctuations or vibrations in the fluid system can be dampened, reduced, or ideally completely compensated for. Accordingly, the compensation element according to the disclosure makes it possible to keep the pressure in the fluid conduit at a predefined level with at the same time very low deviation from this value.

In the present context, the term damping can be considered to refer to the removal of pressure-related energy from the closed fluid circuit. In this sense, it is rather a matter of reducing the pressure fluctuation in the medium than of damping in the sense of damping mechanical vibrations. To remove this energy, work is required that is not 100 percent efficient and leads to heat generation. When designing the compensation element, it should be ensured that no significant heat is added to the medium in which the pressure fluctuations are reduced.

Ideally, this results in the input amplitude of the vibration decaying to zero when measured at the outlet, so that the vibration that occurs is completely compensated for. In the sense of the disclosure, however, damping can also be understood to mean that the input amplitude of the vibration to be damped decreases by at least 50%, preferably by at least 60%, and most preferably by at least 70% or even 90%, 99% or more, for example by 99.5% or more. The output amplitude at the outlet of the compensation element is therefore preferably no more than 50%, 40%, 30%, 10% or even 1% or less, for example 0.5% or less, compared to the input amplitude. For the purposes of the disclosure, it is furthermore intended that this damping is accomplished in the shortest possible time.

This relates to a frequency range from about 0.01 Hz to about 20 kHz, preferably from 0.1 Hz to 100 Hz.

A mass flow controller (MFC) can be used to control a mass flow rate to a setpoint value. However, these devices usually do not have the required dynamic range to control and adjust a very small or very large mass flow rate, as they exhibit a rather slow response behavior.

When switched on, time-delayed overshooting can occur, i.e. the setpoint value might be exceeded or overdriven, but also underdriven or undershot, which is unfavorable for the disclosure where very sensitive processes are involved.

Therefore, according to a further aspect of the disclosure, the compensation element according to the disclosure can also serve to provide a very precise constant mass flow rate of the fluid from start-up to shut-down, with low inertia when switched on and off.

Within the sense of the disclosure, a portion of the internal volume of the hollow body can be used for this purpose, in particular the compensation volume, which can be actively increased or reduced in order to compensate for or at least minimize pressure fluctuations occurring in the fluid conduit.

To this end, the compensation volume provides the volume that can be specifically and actively changed by the actuator during operation in order to compensate for pressure fluctuations in the fluid conduit. Within the sense of the disclosure, the compensation volume can be decreased or increased by an active movement, for example a stroke movement, of the actuator. In other words, the actuator is designed to change the compensation volume during operation and in this way to compensate for pressure fluctuations in the fluid conduit.

The actuator may comprise an actuator based on a magnetic principle, a piezo principle or an electrostatic principle. Such actuators are characterized by a direct and rapid response behavior for their intended or suitable area of application and can also be operated very precisely in their mechanical movement by appropriate electrical control. Further refinements of the disclosure also envisage combinations which combine actuators that are based on different principles in order to expand the range of application.

Generally, a deformation of the actuator can be caused by applying a voltage that can be controlled by a controller, which deformation can lead to a change in volume of the actuator inside the hollow body. By increasing the compensation volume remaining in the hollow body, a positive pressure surge can virtually be absorbed. A negative pressure change can be absorbed by reducing the compensation volume.

According to one embodiment of the disclosure, it is intended to select an actuator with a piezoelectric material for the actuator, which can operate in liquid fluids or is resistant to liquid fluids.

According to one embodiment of the disclosure, the actuator may be protected so that it can be operated in conjunction with or in contact with aggressive or corrosive fluids, in particular “ultra-pure water” and/or fluorine-containing fluids. For example, coatings or protective layers can be provided, which are resistant to the fluids. In the case of aggressive or corrosive fluids such as low-salt pure or in particular ultra-pure water, suitable anti-corrosion coatings are considered, for example based on or comprising tantalum, Inconel, molybdenum, or combinations thereof. PVD coatings are also conceivable, for example. It goes without saying that the other fittings and/or installation components should also be protected accordingly.

In this way, it is possible to arrange the actuator directly in the internal volume. The desirability of this embodiment of the disclosure is that the piezoactive material or the piezo actuator can be placed directly inside the cavity, and no additional components are required to protect the actuator, since it can come into direct contact with the fluid from the fluid conduit. In this way, the compensation element can be kept very simple and compact.

By appropriately selecting the geometry of the piezoelectric material and its arrangement in the internal volume of the hollow body, it can be ensured that the change in volume or the stroke movement of the piezoelectric material leads to the desired change in the compensation volume. According to one embodiment of the disclosure, the compensation volume may refer to the volume resulting when the actuator is arranged in the internal volume of the hollow body in a rest position, i.e. in its normal size without electrical influence.

In a further refinement of the disclosure, it is intended that the movement of the actuator on the inlet side of the hollow body is greater than on the outlet side. This improves the damping or absorption of vibrations, and an overall better performance can be achieved.

This can be achieved, for example, if the openings are provided on one side of the hollow body and the piezoelectric material inside the hollow body on the opposite side, and if the distance of the piezoelectric material to the inlet opening is smaller than to the outlet opening. In the case of a rectangular cross-sectional shape of the hollow body, for example, this can be achieved in a very simple way by a correspondingly inclined surface of the body made of the piezoelectric material relative to the openings. The inclination can result in an angle α, which may preferably be at least 1°, more preferably at least 5°, and most preferably at least 10°.

In a likewise preferred embodiment of the disclosure, the internal volume is intended to be divided into two partial volumes by a flexible diaphragm, so that a second volume, which will also be referred to as a balancing volume below, can be defined in addition to the compensation volume. The compensation volume is again associated with the space adjacent to the openings, so that it can receive the medium from the fluid conduit. The compensation volume inside the hollow body is therefore enclosed by the flexible diaphragm so that the medium cannot escape. The actuator may also be arranged outside the compensation volume.

The flexible diaphragm may, for example, comprise a bellows or come in the form of a bellows. Suitable materials that are considered include elastomers, for example, which exhibit sufficient elasticity for the required deformations.

However, in applications under vacuum or deep vacuum, certain materials can be problematic and therefore cannot be used, in particular in combination with aggressive or corrosive media. For this reason, other materials are also used for the disclosure, even strong, less elastic materials of suitable design, in particular metallic materials such as stainless steel or high-grade steel. During operation, the compensation volume can accommodate the medium, such as a fluid from the fluid conduit.

The desirability of such an arrangement is that the actuator is protected from the medium by the flexible diaphragm. This makes it possible to use other materials or actuators that are not or cannot be designed to be resistant to the media in the fluid conduit. The compensation volume can again be changed by a respective movement of the actuator as described above.

In a further refinement of the disclosure, a pressure body is provided, which can be moved by the actuator and can thereby act on the flexible diaphragm. The application of force by the actuator onto the flexible diaphragm can thereby be improved or simplified.

The movement of the actuator and thus the size of the compensation volume can be controlled by a controller which can be monitored and controlled by an electronic computer unit. The computer unit can be used to determine an input value for the actuator and to transmit it to the actuator for controlling the compensation. In this way, the voltage applied to the actuator can be controlled, in order to change the size of the compensation volume.

According to one embodiment of the disclosure, the actuator and thus the size of the compensation volume are controlled by the computer unit based on the deviation of the current pressure at the inlet opening from a predefined pressure. Accordingly, a total pressure can be present at the inlet opening, which is composed of the predefined pressure P and the pressure difference ΔPᵢₙ.

Thus, the total pressure on the inlet side is therefore given by

Pᵢₙ=P+ΔPᵢₙ.

Alternatively or additionally, the total pressure can also be measured at one or more locations in the fluid conduit on the side that is exposed to potential pressure fluctuations.

For this purpose, appropriate sensors or pressure measuring devices may be installed in the inlet opening of the hollow body and/or in the fluid conduit, which will be discussed in more detail below.

The computer unit may therefore be provided with data on the pressure conditions prevailing in the fluid conduit, whereupon it can calculate an input value for the electrical voltage of the actuator. The input value therefore corresponds to the voltage that should be applied to the actuator in order to cause it to change the volume of the compensation volume, which can compensate for the pressure difference. In this way, the actuator can perform a movement adapted to the pressure deviation ΔPᵢₙ, which allows to reduce the pressure difference or ideally completely compensate for the pressure difference by changing the compensation volume in the hollow body. Thus, a pressure fluctuation occurring in the fluid conduit can be minimized or ideally completely compensated for, so that the following applies to the total pressure Pₒᵤₜ at the outlet opening: Pₒᵤₜ=≈P or ideally Pₒᵤₜ=P.

In other words, in this embodiment of the disclosure it is intended to change the compensation volume by an appropriate movement of the actuator on the basis of the pressure fluctuation in the fluid conduit in such a way that the predefined value for the pressure will be present at the outlet of the hollow body and the pressure fluctuation is thus zero or almost zero.

The controlling of the compensation element may be accomplished according to a “feedback control” procedure or as a closed-loop control in order to reduce the pressure fluctuation. The required movement of the actuator is determined by suitable filters in the control system. When designing the control system, it is advisable to take into account non-linear and/or hysteresis effects of the actuator, for example of the piezoelectric material, in order to prevent overshooting, i.e. excessive damping.

In a refinement of the disclosure, the flow velocity of the medium, in particular the fluid, is also taken into account for the controlling of the compensation element. For this purpose, appropriate measuring devices or sensors, for example pitot tubes, may be provided at a suitable location in the fluid conduit.

Alternatively or in addition to this feedback control, a further embodiment of the disclosure may also have integrated into the controlling a “feed forward” procedure or disturbance variable feedforward, in order to increase the effectiveness even further. For this purpose, the pressure fluctuation is also measured downstream, i.e. in the fluid conduit which is connected to the outlet opening of the hollow body, and is fed into the control loop in an appropriately filtered form.

According to a further embodiment of the disclosure it is intended to use the pressure force acting on the actuator as the leading control parameter. The aim of this control strategy is to control the actuator in such a way that the changes in the pressure force are minimized or compensated for. Accordingly, the force acting on the actuator is kept as constant as possible. In this case, a force sensor or force transducer may additionally be provided on the actuator, which may be arranged between the actuator and the compensation volume and which detects a change in the pressure force as a result of a change in the compensation volume.

In this embodiment of the disclosure, an actuator, for example a piezo actuator, may be combined with a piezo-based force sensor.

The desirability of a piezo-based force sensor is that it cannot measure the constant continuous flow pressure and only captures changes in force. In a piezo-ceramic element of this type, the application of a force produces a charge distribution that is proportional to the force and can be measured. Piezo-based force sensors can be used to measure pressure forces or shear forces. One reason for using piezo-based force sensors is that they are able to measure highly dynamically.

The desirability of this control strategy is that no pressure sensor is required in or on the fluid conduit. These sensors can be very sensitive, so that complex monitoring of the functionality of these sensors might be required during operation.

In one embodiment of the disclosure, a pressure sensor is provided for measuring the total pressure. This makes it possible to measure fluctuations or differences in the total pressure with an accuracy of 0.1 Pa or better, preferably 0.05 Pa or even 0.01 Pa, even at a high pressure, for example at a pressure of 50 kPa or more, preferably 100 kPa or more.

The pressure sensor according to the disclosure is adapted to capture a relative pressure. Such a pressure sensor evaluates the pressure difference on two sides of the sensor element. If the mean pressure is the same on both sides, it is possible to measure fluctuations in the mPa range. One input of the pressure sensor can be connected directly to the fluid conduit. This ensures that all pressure fluctuations can be detected on this side. However, a high total pressure is prevailing on this side. Pressure feedback to the other input of the pressure sensor can be given from an appropriately chosen distance downstream in the fluid conduit. By using a capillary tube with an appropriate length and an appropriate diameter and utilizing the volume at the pressure sensor, it can be ensured that pressure fluctuations above a certain frequency cannot reach this side of the pressure sensor. In this way, a low-pass filter can be defined, with a cutoff frequency that is determined by the geometry of the capillary passage and the volume of the pressure sensor. This configuration causes the pressure sensor to not measure the constant pressure, but only detects the fluctuations above the cutoff frequency of the low-pass filter. This principle can be used for the feedforward sensor by connecting the capillary tube downstream of the pressure actuator. For the feedback sensor, both the main connection and the capillary tube are connected downstream of the pressure actuator.

In addition to the above-mentioned embodiments for a compensation element for actively damping vibrations of a medium, various other embodiments are possible and envisaged, in particular with regard to the actuator and the sensors, some of which will be presented below. It will be appreciated that it is also possible and envisaged to combine these embodiments with one another. It should also be noted that this list is not to be regarded as exhaustive.

In an embodiment of the disclosure, the compensation element may comprise three active elements:
an optional pressure sensor at the inlet of the compensation element to measure the disturbance entering the compensation element on the upstream side;
an actuator adapted for changing the size of the compensation volume in such a way that the pressure fluctuation in the medium can be influenced; and
an optional pressure sensor at the outlet of the compensation element, downstream, which can be used as a feedback sensor.

For most embodiments, at least one pressure sensor is provided, or two pressure sensors as described above are used, which can serve to improve performance. These three elements may be combined into one unit or may else be used as three separate elements that can be connected with (short) lines, hoses or tubular elements if required.

The changing of the compensation volume is an desirable aspect of the disclosure. This change may be accomplished using a piston-like component that moves up and down, but also by deforming a closed compensation volume that contains the liquid. The compensation volume may also be a flexible hose or a flexible tube, which can be deformed in a targeted and controllable manner, or a type of bellows component which is compressed or expanded to bring about the desired volume change.

Accordingly, in one refinement of the disclosure, a compensation element for the active damping of vibrations of a medium, in particular a fluid, is provided, in which a hollow body with an internal volume is already provided by the fluid conduit.

Thus, the internal volume of the fluid conduit provides the compensation volume which can be increased or decreased by an actuator during operation. The actuator can be arranged outside the internal volume. The fluid conduit may be curved or formed with a curvature, at least in sections thereof. The actuator may be arranged between two opposing curved sections of the fluid conduit and be firmly connected to the outside of the sections. During operation, the actuator is able to exert a pulling or pushing movement on the two sections of the fluid conduit so that these sections can be pulled together or pushed apart.

In this way, the size of the internal volume provided by the fluid conduit can be changed. It will be appreciated that the fluid conduit can be designed so as to exhibit adequate resiliency in order to support the movement by the actuator.

To this end, the fluid conduit may be made of an elastic plastics material, for example.

In the case of applications under vacuum or deep vacuum, for applications in the field of lithography, or in the case of electron beam apparatuses, and/or aggressive or corrosive media, however, plastics materials might be problematic and therefore cannot be used. For this reason, metallic materials such as stainless steel or high-grade steel are also envisaged, or alternatively or additionally coatings, for example PVD coatings.

The curvature may also take the form of a full circle or a complete loop of the fluid conduit. The effect can be increased even further if more than one loop is provided, for example two, three or four loops.

In yet another refinement of this embodiment of the disclosure, a compensation element is provided for actively damping vibrations of a medium, in particular a fluid, in which a hollow body with an internal volume is again provided by the fluid conduit. The internal volume of the fluid conduit thus provides the compensation volume, which can be increased or decreased by an actuator during operation. The actuator can be arranged outside the internal volume.

According to this embodiment, the fluid conduit may be designed so as to be straight. The fluid conduit may be fixed by at least two spaced-apart support points, and the actuator can preferably be arranged centrally between these two support points. The actuator is connected to the outside of the fluid conduit, preferably approximately centrally between the two support points and opposite thereof.

When the actuator exerts a pulling force or a pushing force on the fluid conduit during operation, this can cause a radial movement of the fluid conduit between the two support points, which can cause a deflection of the fluid conduit in this section, whereby the compensation volume can also be changed and adjusted in order to compensate for a pressure fluctuation.

According to yet another refinement, it is suggested to fix the side of the fluid conduit opposite the side on which the actuator acts. A pressing force from the actuator will then enable to move the wall of the fluid conduit on the side facing the actuator towards the opposite wall of the fluid conduit, so that the compensation volume can also be reduced. In comparison to the previously mentioned embodiment with only two support points, a higher pressing force from the actuator will be necessary in this embodiment.

It goes without saying that in the case of these embodiments, again, a certain flexibility or resiliency of the fluid conduit has to be ensured.

Accordingly, in a further aspect, the present disclosure relates to a compensation element for actively damping vibrations of a medium, in particular a fluid, in which a hollow body having an internal volume is already provided by the fluid conduit itself. The required change in volume for actively damping vibrations can be brought about by a substantially radial deflection of the fluid conduit as a whole or by deflection of only one wall of the fluid conduit by the actuator during operation.

According to yet another refinement it is intended for the fluid conduit to be adapted so as to be flexible along its longitudinal extension. To this end, it may comprise a type of bellows, for example, so that an axial change in length of the fluid conduit is enabled instead of a radial deflection. For this purpose, the actuator may be arranged parallel to the axis and can cause a longitudinal change in the fluid conduit within the range of the bellows by appropriate tensile forces or compressive forces, which can likewise cause a change in volume.

Accordingly, in a further aspect, the present disclosure relates to a compensation element for actively damping vibrations of a medium, in particular a fluid, in which a hollow body having an internal volume is already provided by the fluid conduit itself, and in which the required volume change for actively damping vibrations can be brought about by a longitudinal change of the fluid conduit.

Also encompassed by the disclosure, in a further aspect of the disclosure, is a method for actively damping vibrations of a medium, in particular a fluid, which comprises the following steps:
providing a compensation element;
capturing the total pressure of a medium in a fluid conduit using a pressure sensor;
determining the inlet side pressure difference ΔPᵢₙ relative to a predefined pressure P;
calculating an input value for an electrical parameter, in particular for the electrical voltage, for an actuator, and transmitting the input value to the actuator;
using the actuator to change the compensation volume on the basis of the input value for decreasing or increasing the compensation volume in such a way that the pressure difference can be compensated for by the change in volume.

In a preferred embodiment of the disclosure, the method involves a compensation element as described above.

In a further aspect of the disclosure, a system is also encompassed for actively damping vibrations or oscillations of a medium, in particular a fluid, which is adapted for performing a method for actively damping vibrations or oscillations of a medium, in particular a fluid, as described above. The system may comprise a compensation element as described above.

The system according to the disclosure can be used for cooling machines, installations or other equipment, whereby these machines, installations or equipment are protected from pressure fluctuations and associated vibrations.

More generally, the compensation element according to the disclosure or the system according to the disclosure for actively damping vibrations or oscillations of a medium can also be used in various installations or processes in which a mass flow rate is to be controlled as precisely and/or quickly as possible to a setpoint value, and/or in which a temporally limited mass flow rate of a fluid is to be ensured, for example also for mixing fluids.

This may, for example, also include various processes or systems in the chemical industry, the semiconductor industry, lithography, or even electron beam devices, reactor chambers, etc.

The system may comprise a fluid conduit that is at least partially filled with a medium, in particular with a fluid such as water or oil, in which a specific total pressure can be set during operation, for example 1 Pa, 100 Pa, 1 kPa, 10 kPa, or even 100 kPa.

The compensation element according to the disclosure makes it possible to ensure that during operation a pressure fluctuation in this system is +/−10 mPa or less, preferably +/−5 mPa or less, most preferably +/−5 mPa or less.

The disclosure thus makes it possible to be used on or with fluid lines and machines, installations or other equipment connected thereto, for example in the semiconductor industry sector, which are highly sensitive to pressure fluctuations and/or temperature fluctuations. For example, this also makes it possible to prevent deformations in or on the machines, installations or other equipment, for example in the semiconductor industry sector.

For example, a water cooling circuit is envisaged here, to which semiconductor industry installations or equipment are connected, and which respond sensitively to pressure fluctuations and/or temperature fluctuations in the water cooling circuit, or which have sensitive parts.

In one aspect, the disclosure also relates to a system for controlling a mass flow rate of a medium, in particular of a fluid, which comprises a compensation element according to the disclosure as discussed above.

According to a further aspect of the disclosure, this system can be used for dosing fluids or for mixing fluids.

This mass flow rate may, for example, refer to a fluid circulating in a reactor chamber. A block flux or mass flux of any kind can be flexibly defined and better implemented in this way, since inertia of the system is very low.

Further details of the disclosure will be apparent from the description of the illustrated embodiments and the appended claims.

### IN THE DRAWINGS

FIG. 1 is a sectional view showing the basic configuration of a compensation element according to the disclosure for actively damping vibrations of a medium;

FIG. 2 is a sectional view showing the basic configuration of a compensation element according to the disclosure for actively damping vibrations of a medium by way of an embodiment in which the internal volume is divided into a compensation volume and a balancing volume;

FIG. 3 is a sectional view showing the basic configuration of a compensation element according to the disclosure for actively damping vibrations of a medium by way of an embodiment in which the internal volume is divided into a compensation volume and a balancing volume according to a further embodiment which comprises a force sensor on the actuator;

FIG. 4 shows an embodiment of a system for actively damping vibrations of a medium using a compensation element;

FIG. 5 shows the basic structure of a pressure sensor that is particularly suitable for the compensation element;

FIG. 6 is a side view showing the basic configuration of another compensation element according to the disclosure for actively damping vibrations of a medium, in which the hollow body is already provided by the fluid conduit which is curved at least in sections thereof;

FIG. 7 is a side view showing the basic configuration of yet another compensation element according to the disclosure for actively damping vibrations of a medium, in which the hollow body is already provided by the fluid conduit and in which the fluid conduit comprises at least one straight section;

FIG. 8 is a side view showing the basic configuration of yet another compensation element according to the disclosure for actively damping vibrations of a medium, which is based on the embodiment of FIG. 7, comprising continual support of the fluid conduit at least in the straight section;

FIG. 9 is a side view showing the basic configuration of yet another compensation element according to the disclosure for actively damping vibrations of a medium, in which the hollow body is already provided by the fluid conduit and in which the volume change occurs along the longitudinal extension of the fluid conduit; and

FIG. 10 shows a comparison of the response behavior of the control according to the disclosure.

### DETAILED DESCRIPTION OF PREFERRED EMBODIMENTS

In the following detailed description of preferred embodiments, the same reference numerals designate substantially similar parts in or on these embodiments, for the sake of clarity. However, to better illustrate the disclosure, the preferred embodiments shown in the figures are not always drawn to scale.

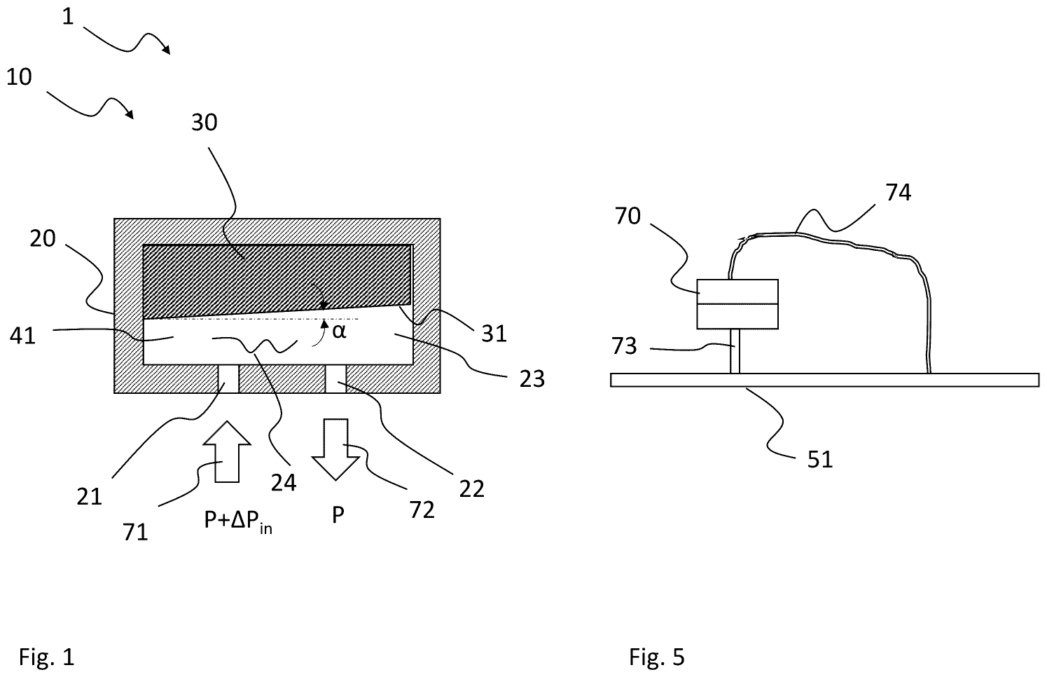

FIG. 1 is a sectional view showing the basic configuration of an embodiment of a compensation element 1 according to the disclosure for actively damping vibrations of a medium, in particular a fluid, which is illustrated by the curved line 24 in the diagram, for illustrative purposes only.

The compensation element 1 in the embodiment of FIG. 1 comes in the form of a compensation element 10 comprising an actuator 30 which is arranged in an internal volume 23 of a hollow body 20.

The following figures show further preferred configurations and embodiments of compensation elements 1 according to the disclosure, which are designated by reference numerals 11, 12, 13, 14, 15, and 16, respectively.

The compensation element 1, 10, 11, 12, 13, 14, 15 and 16 comprises
a hollow body 20 having an internal volume 23, with a compensation volume 41 being formed in the internal volume 23, with the hollow body 20 further having at least two openings 21, 22 which allow to connect the compensation volume 41 to the environment; and
at least one actuator 30 which is arranged inside the internal volume 23 and allows to increase or decrease the compensation volume 41 during operation.

When designing the compensation elements 1, 10, 11, 12, 13, 14, 15, and 16, care should be taken to ensure that turbulent flows, which might also be caused by the compensation element itself, are avoided as far as possible.

The medium 24 may be provided in gaseous or liquid form, and in the present case it comprises a liquid fluid with low compressibility, for example oil or water. The medium 24 is accommodated in a piping system, a fluid conduit, a hydraulic line, a pressure line, or more generally in any suitable container or vessel.

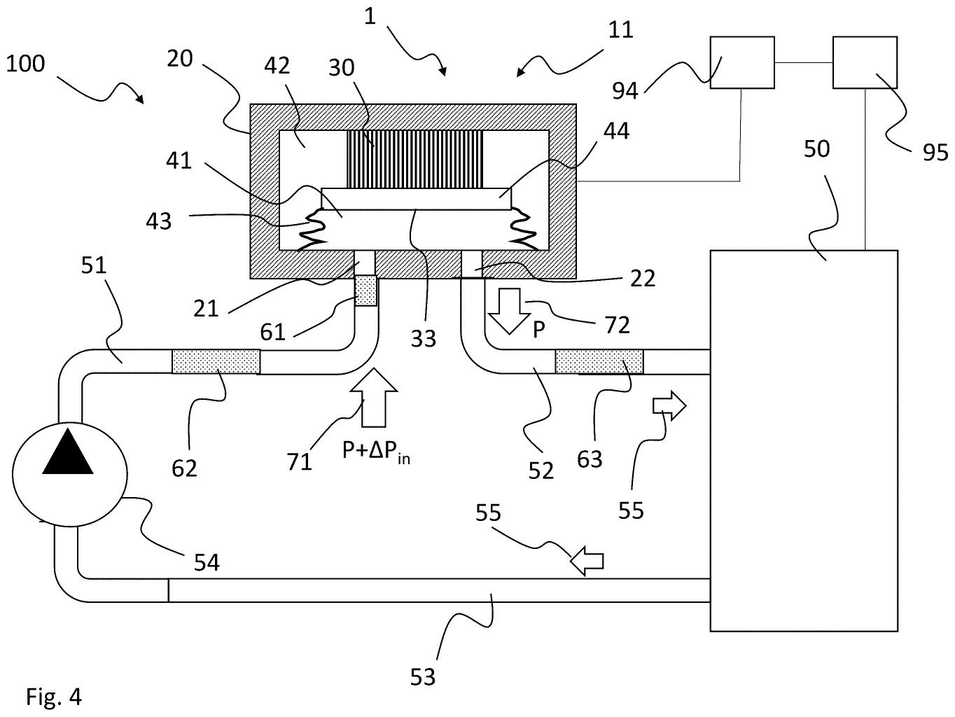

Fluid conduits 51, 52, 53 are shown merely as examples for illustrative purposes in FIG. 4, which shows an embodiment of a system 100 for actively damping vibrations of a medium 24, in particular a fluid, in which the compensation element 11 is used. Fluid conduit 51 designates the fluid conduit in which the medium 24 is supplied. For this purpose, the fluid conduit 51 may be connected to a pump 54, for example, which is shown in FIG. 4 merely for illustrative purposes.

The arrangement is such that the pressure fluctuations to be compensated for occur in fluid conduit 51, which therefore represents the supply line in the direction of flow.

Reference numeral 52 designates the fluid conduit which in the embodiments of FIGS. 1, 2, 3, and 4 is arranged downstream of and leads away from compensation element 11 in the direction of flow. The system 100 of FIG. 4 will be discussed in more detail further below.

For the sake of clarity, the fluid conduit is not shown in FIG. 1. During operation, the fluid conduit and the compensation volume 41 are filled with the viscous medium 24, in the example with a liquid fluid. In the embodiments, the fluid conduit and the compensation volume 41 are completely filled with the fluid.

The medium 24 may in particular also comprise low-salt water, pure water, and high-purity water, or in particular “ultra-pure water”, as required and specified for the semiconductor industry. It is also possible to use the compensation element with fluorine-containing media, in particular fluids, such as fluorine-containing liquids, in particular water.

More generally, the medium 24 may also comprise aggressive and/or corrosive fluids, i.e. liquids and gases.

During operation, the openings 21, 22 of the compensation element 10 are connected to the fluid conduit 51, 52 in a force-fitting and/or form-fitting manner. For this purpose, suitable connecting means, e.g. sleeves, screw connections or other suitable fittings are provided to form a force-locking and/or form-locking join between the fluid conduit 51, 52 and the openings 21, 22.

In the embodiment, these connections are also separable in a non-destructive manner, so that the compensation element can be easily installed and replaced. For actively dampening vibrations, the compensation element is connected to the fluid conduit 51, 52 in a mechanically solid and fluid-tight manner. In the present context, mechanically solid means that the connection is sufficiently resistant to pull-out and vibration during operation, which is ensured by suitable structural dimensions and the choice of the material for the joining partners depending on the specific application.

In operation, the first opening 21 is used as an inlet or inlet opening for supplying the medium 24, and the further opening 22 is used as an outlet or outlet opening for discharging the medium 24 once the corresponding fluid conduits 51, 52 have been mounted.

During operation, the opening 22 of the hollow body 20 thus provides the outlet for the medium 24 which can enter the internal volume 23 of the hollow body 20 via the inlet 21. Pressure fluctuations in the fluid conduit 51 supplying the fluid can be at least reduced or ideally fully compensated for by the compensation element. In other words, pressure fluctuations on the inlet side are only passed on to or into the fluid conduit 52 connected to the outlet 22 to a reduced degree or ideally not at all.

A vibration or oscillation occurring at the inlet 21 with an input amplitude is thereby dampened, so that the output amplitude at the outlet 22 will be lower than the input amplitude. The output amplitude at the output 22 of the compensation element is therefore preferably not more than 50%, 40%, 30%, 10%, or even 1% or less, for example 0.5% or less, in comparison to the input amplitude.

In FIG. 1, reference numeral 71 indicates the pressure P+ΔPᵢₙ applied on the inlet side, and reference numeral 72 indicates the pressure P on the outlet side, for illustrative purposes.

Pressure fluctuations or pressure surges can occur due to dynamic pressure changes and can be transmitted through the medium 24 in the fluid conduit 51. Excessive pressure surges can cause damage to or in the affected systems 100 or to machines 50, installations or other equipment connected to the system 100, for example in the semiconductor industry sector. The fittings directly connected to the fluid conduit 51, 52, pumps 54, or even foundations may also be damaged by pressure surges.

At least part of the internal volume 23 of the hollow body 20 is intended to be used as a compensation volume 41, which can be actively enlarged or reduced in order to compensate for or at least minimize pressure fluctuations occurring in the fluid conduit 51, 52. Longitudinal waves in the viscous medium 24 as a result of these pressure surges can be practically absorbed by the compensation volume 41.

The compensation volume 41 provides the volume that can be specifically and actively changed during operation by the actuator 30 in order to compensate for these pressure fluctuations in the fluid conduit 51, 52. To this end, the actuator 30 can reduce or enlarge the compensation volume 41 by a movement, for example a stroke movement.

In the embodiment of FIG. 1, the actuator 30 is arranged in the internal volume 23 of the hollow body 20 on the inner wall. This provides for a particularly simple design. The choice of geometry and thus the volume occupied by the actuator 30 are selected in such a way that the compensation volume 41 is given by the remaining volume when the actuator 30 is arranged in its rest position in the hollow body 20.

In this embodiment of the disclosure, an actuator with a piezoelectric material is provided for the actuator 30, which can operate in liquid media or is resistant to the medium 24.

For this purpose, the actuator is provided with an anti-corrosion coating, for example based on materials including tantalum, Inconel, molybdenum, or combinations thereof. PVD coatings are also possible. Certain high-purity plastics materials may also be suitable materials, including for example PVDF-HP, ECTFE, or even ceramic materials such as SiC.

This embodiment allows to dispense with further components, for example to protect the actuator 30. In this way, the compensation element 10 can be kept very simple and compact. The geometry and the material of the actuator 30 are selected such that the movement of the piezoelectric material leads to the desired change in the compensation volume 41 during operation.

More generally, the actuator 30 may also have other geometries or may be made of other materials and be based on a magnetic principle, piezo principle or electrostatic principle. It may be desirable for the actuator 30 to have a direct and rapid response behavior.

By applying a voltage, a deformation of the actuator 30 can be caused, which leads to a change in the volume of the actuator 30 inside the hollow body 20. By increasing the compensation volume 41, a positive pressure surge can be absorbed. A reduction in the compensation volume allows to absorb a negative pressure change or a negative pressure.

In the embodiment of the disclosure shown in FIG. 1, the movement of the actuator 30 at the input side and/or the distance of the actuator 30 to the input side, i.e. in the vicinity of opening 21, is greater than at the output side, i.e. in the vicinity of opening 22. This improves the damping properties.

In the embodiment, this is achieved by an inclined surface 31 of the body of the piezoelectric material. The inclination as indicated by the angle α in FIG. 1 results in a different distance to the two openings 21, 22. The angle α is at least 1°, preferably at least 5°, and particularly preferably at least 10°. In the illustrated embodiment, the angle α is approximately 5°.

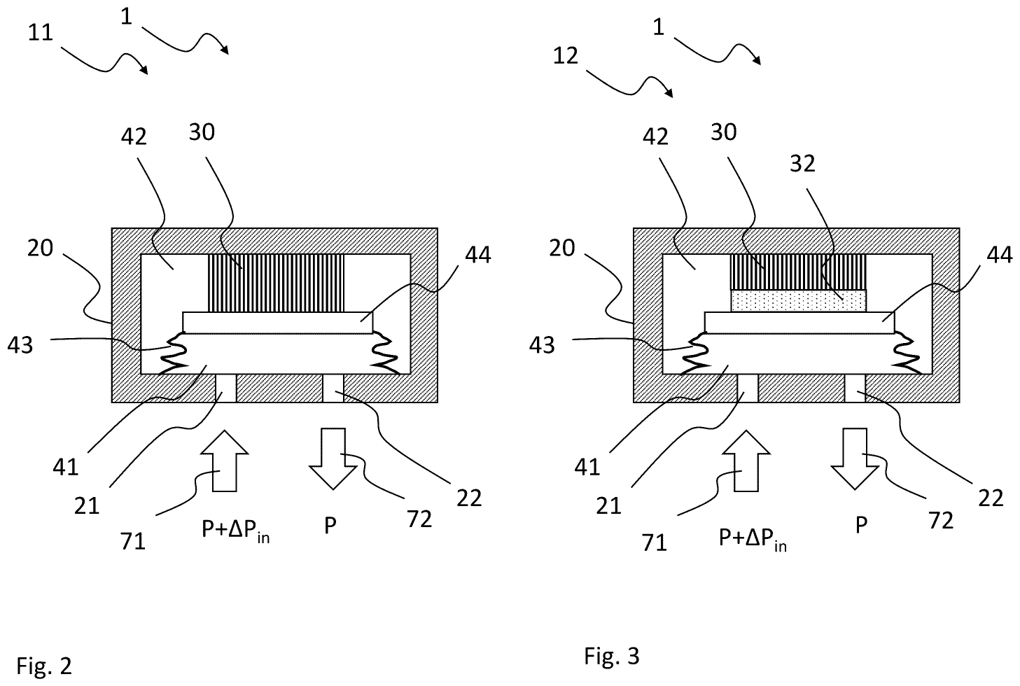

According to a further embodiment of the disclosure, it is intended to divide the internal volume 23 into two partial volumes. FIGS. 2 and 3 are sectional views showing the basic configuration of two compensation elements 11, 12 according to the disclosure for actively damping vibrations of a viscous medium 24 by way of two embodiments in which the internal volume 23 is divided into a compensation volume 41 and a balancing volume 42, in a sectional view.

Here, a flexible diaphragm 43 is provided, which separates the compensation volume 41, whereby a balancing volume 42 is established in the internal volume 23. The compensation volume 41 is again associated with the space adjacent to the openings, so that it can receive the medium 24 from the fluid conduit 51, 52. The compensation volume 41 inside the hollow body 20 is therefore enclosed by the flexible diaphragm 43 so that the medium 24 cannot escape.

The desirability of these embodiments is, for example, that the actuator 30 is arranged in a protected manner outside the compensation volume 41 and is thus protected from direct exposure to the medium 24. This makes it possible to use other materials or actuators that are not resistant to the viscous media 24. The compensation volume 41 can again be changed by a respective movement of the actuator 30.

The flexible diaphragm 43 may, for example, comprise a bellows or be in the form of a bellows, as shown in FIGS. 2 and 3. Materials envisaged for this generally include elastomers that exhibit sufficient elasticity for the required deformations, such as rubber, or else metallic materials such as stainless steel or high-grade steel of appropriate design. When selecting the material, care should be taken to ensure that the required pressure values occurring during operation can be withstood.

During operation, the compensation volume 41 receives the medium 24, such as a fluid from fluid conduit 51. In the embodiment of the compensation element 11 of the disclosure as shown in FIG. 2, a pressure body 44 is provided, which can be moved by the actuator 30 and can thereby act on the flexible diaphragm 43. The application of force from the actuator 30 to the flexible diaphragm 43 can thereby be improved or simplified.

The movement of the actuator 30 and thus the size of the compensation volume 41 is controlled by a controller 94 which is monitored and controlled by an electronic computer unit 95.

The computer unit uses stored programs or value tables to determine an input value for the actuator 30, which is transmitted to the actuator to control the compensation. The controller or another component suitable for controlling can be used for this purpose. The input value relates to at least one electrical parameter, in the embodiment the voltage applied to the actuator 30. The movement of the actuator 30 or its expansion is controlled by the voltage applied. This influences and adjusts the size of the compensation volume 41 accordingly.

According to a preferred embodiment of the disclosure, the actuator 30 and thus the size of the compensation volume 41 are controlled by the computer unit on the basis of the deviation of the current pressure at the inlet opening 21 from a predefined pressure. Accordingly, a total pressure is present at the inlet opening 21 during operation, which is composed of the predefined pressure P and the pressure difference ΔPᵢₙ.

The total pressure on the inlet side is therefore given by Pᵢₙ=P+ΔPᵢₙ. Alternatively or additionally, the total pressure can also be measured at one or more locations in the fluid conduit 51 on the side which is exposed to the potential pressure fluctuations.

In FIG. 4, this is schematically illustrated by the two pressure sensors 61, 62, which are associated with the inlet 21 on the one hand and with the fluid conduit 51 on the other hand. If the pressure sensor 62 in fluid conduit 51 is arranged at a sufficient distance from the opening 21, a certain lead time may be resulting, due to the fact that a pressure change occurring downstream during operation will first be detected by pressure sensor 62 and then, with a time delay, by pressure sensor 61. This makes it possible to control the actuator 30 proactively, so that the pressure difference can be compensated for even better. Actuator 30 is controlled in real time. In this way, a pressure difference can be compensated for in real time.

To this end, the control system is designed with a high bandwidth so that it can respond to very slow changes, for example in the range of less than 0.01 Hz, but also to high frequencies of up to 10 kHz. This can be achieved in both analogue and digital manner. A fundamentally suitable control system can be found in Applicant's document EP 1 840 681 A1 which is hereby included and thus fully incorporated into the subject-matter of the present disclosure in its entirety.

Using stored algorithms, the computer unit determines, based on the data from the pressure sensors 61, 62, an input value for the electrical voltage to be applied to the actuator 30.

Instead of permanently programmed algorithms for the controlling or adjusting of the compensation element, it is also envisaged in a further refinement of the disclosure to use methods of “machine learning” or artificial neural networks to support the controlling.

This can be helpful, for example, if a plurality of compensation elements comprising a plurality of actuators are to be controlled and regulated jointly, and/or if a plurality of compensation elements are connected together to form a larger, complex group or network of fluid conduits. Then, in yet another refinement of the disclosure, further data or parameters from other installations, machines or systems connected to the network can also be taken into account for the controlling or adjustment strategy, for example room temperatures or temperatures at or in the installations or machines 50.

PID controllers can also be used for the controlling.

In this way, the actuator control can be transferred to a self-learning mode and, for example, recognize certain patterns in the pressure changes so that compensation can be accomplished even more quickly and precisely. For this purpose, pressure sensors may also be arranged at several locations in the fluid conduit 51, 52, 53, for example upstream of pumps, valves or similar fittings, so that information about pressure changes can be captured very early on.

Thus, in one embodiment of the disclosure it is also intended to take into account the flow rate of the medium 41, in particular of the fluid, for controlling the compensation element.

The actuator 30 performs a movement adapted to the pressure deviation ΔPᵢₙ, so that the pressure difference is reduced or ideally completely compensated for inside the hollow body 20 by adjusting the compensation volume 41. In this way, a pressure fluctuation occurring in fluid conduit 51 can be minimized or ideally completely compensated for, so that the following applies to the total pressure Pₒᵤₜ at outlet opening 22: Pₒᵤₜ=≈P, or ideally Pₒᵤₜ=P, and hence ΔPᵢₙ≈0 Pa, or ΔPᵢₙ=0 Pa.

In one embodiment of the disclosure, controlling is accomplished according to the feedback control procedure or as closed-loop control. The required movement of the actuator 30 is determined by suitable filters in a control system. When designing the control system, non-linear and/or hysteresis effects of the actuator 30, such as of the piezoelectric material, are already taken into account in order to prevent overshooting, i.e. excessive damping.

Alternatively or in addition to this feedback control, it is also possible, in a further embodiment of the disclosure, to integrate into the control a “feed forward” procedure or feedforward of a disturbance variable in order to increase the effectiveness even further. For this purpose, the pressure fluctuation is also measured downstream, i.e. in the embodiment in the fluid conduit 52 which is connected to the outlet opening 22 of the hollow body 20. In FIG. 4, a further pressure sensor 63 is shown, merely as an example.

While in these embodiments the pressure sensors are associated with the components carrying the medium 24, i.e. inlets 21, 22 or fluid conduits 51, 52, FIG. 3 shows an embodiment of a compensation element 12 which is based on the embodiment of FIG. 2, but additionally comprises a force sensor or force transducer 32 on the actuator 30, and which is therefore arranged between the actuator 30 and the compensation volume 41.

In the embodiment, the force sensor 32 is arranged between the actuator 30 and the pressure plate 44. In this embodiment of the disclosure, the pressure force acting on the actuator 30 is used as a control parameter, as the leading control variable. The force difference ΔF is given as: ΔF=ΔPᵢₙ*A, where A is the size of the exposed surface. In this case, the objective of the control is to minimize the force difference acting on the actuator 30 or, ideally, to compensate for it completely, so that: ΔF≈0 N, or ΔF=0 N.

In this case, the compensation volume 41 is changed during operation as a function of the pressure force acting on the actuator 30. The desirability of this procedure is that no pressure sensor is required in or on the fluid conduit 51, 52.

In one embodiment of the disclosure, a pressure sensor 70 is provided for measuring the total pressure, which can be used particularly well together with the compensation element. Its basic configuration is schematically shown in FIG. 5.

Pressure sensor 70 captures a relative pressure in the fluid conduit 51, by evaluating the pressure difference on two sides of the sensor element. With the same mean pressure on both sides it is possible to measure fluctuations in the mPa range.

One input of the pressure sensor 70 is connected directly to the fluid conduit 51 via a feed line 73. This ensures that all pressure fluctuations can be detected on this side.

From a certain distance downstream in the fluid conduit 51, the pressure is fed back to the second input of the pressure sensor 70. By using a capillary tube 74 of appropriate length and appropriate diameter and utilizing the volume on the pressure sensor 70, it can be ensured that pressure fluctuations above a particular frequency cannot reach this side of the pressure sensor. In this way, a low-pass filter is provided, with a cutoff frequency that is determined by the geometry of the capillary passage 74 and the volume of the pressure sensor 70. This design means that the pressure sensor 70 does not measure the constant pressure, but only detects the fluctuations above the cutoff frequency of the low-pass filter. This principle can be used for the feed-forward procedure.

In this way it is possible to measure fluctuations or differences in the total pressure with an accuracy of 0.1 Pa or better, preferably 0.05 Pa, or even 0.01 Pa, even at a high pressure, for example at a pressure of 50 kPa or more, preferably 100 kPa or more.

Other suitable pressure measurement techniques may include laser interferometers for measuring pressure differences radially and/or axially in a fluid conduit, or else acceleration sensors.

Particularly suitable for the disclosure are measuring techniques or sensors that enable measurement of the pressure difference.

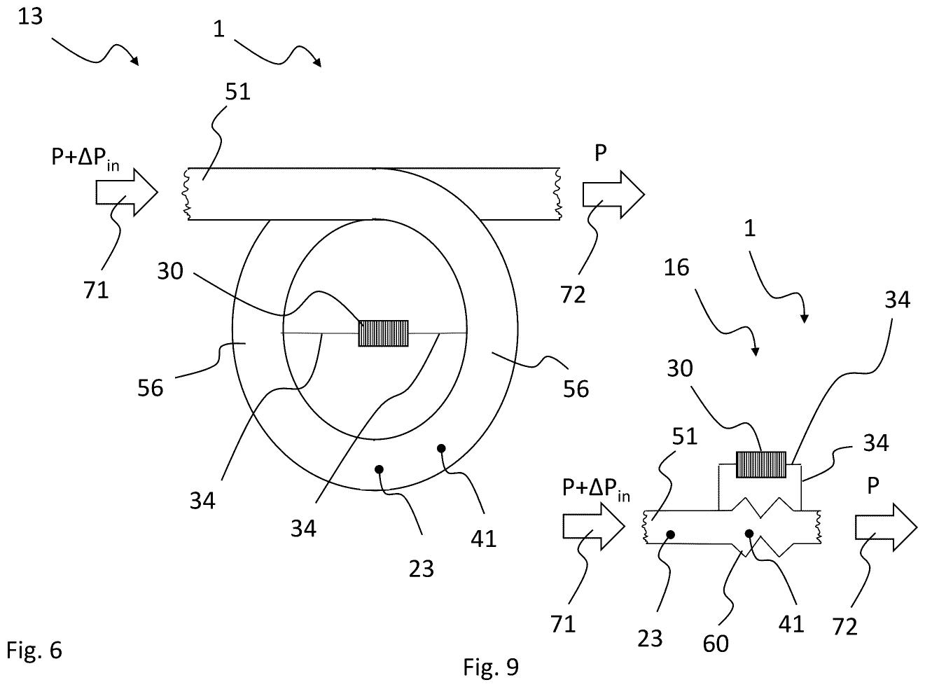

FIG. 6 is a side view showing the basic configuration of another compensation element 13 according to the disclosure for actively damping vibrations of a medium 24, in which the hollow body is already provided by the fluid conduit 51. The latter is curved at least in sections thereof.

The internal volume 32 of the fluid conduit 51, 52 thus provides the compensation volume 41 which can be increased or decreased during operation by the actuator 30. In this embodiment, the actuator 30 is arranged outside the internal volume 32. The fluid conduit 51 is curved at least in sections thereof, or is designed with a curvature.

The actuator 30 is arranged between two opposing curved sections 56 of the fluid conduit 51 here, and is firmly connected to these sections 56. During operation, the actuator 30 can exert a pulling or pushing movement on the two sections 56 of the fluid conduit 51, so that these sections 56 can be pulled together or pushed apart. For this purpose, further force transfer components 34 such as rods or tubes may be provided.

In this way, the size of the internal volume 32 provided by the fluid conduit 51, 52 can be changed. It will be appreciated that the fluid conduit 51 is designed so as to exhibit adequate resiliency and can be made from an elastic plastics material, for example. In the embodiment, a hose is provided.

As shown in the embodiment, the curvature may be in the form of a full circle or a complete loop of the fluid conduit 51. The effect can be increased even further if more than one loop is provided, for example two, three or four loops.

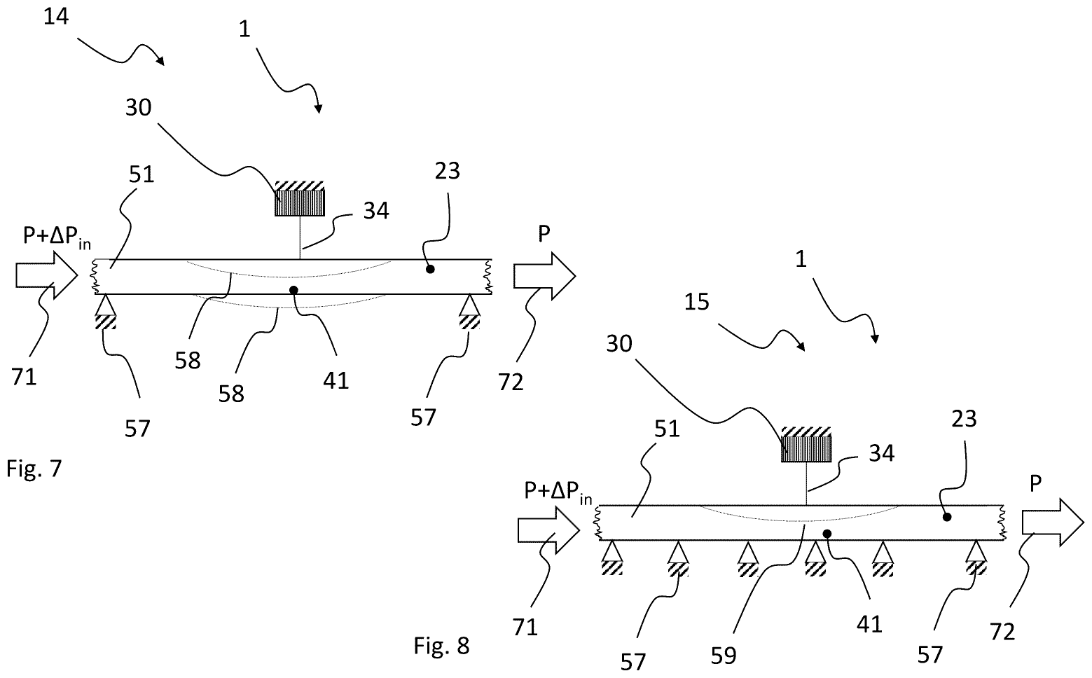

FIG. 7 is a side view showing the basic configuration of yet another compensation element 14 according to the disclosure for actively damping vibrations of a medium 24, in which the hollow body is again already provided by the fluid conduit 51. Instead of a curved section, the fluid conduit 51 according to this embodiment comprises at least one straight section.

The actuator 30 is again arranged outside the internal volume 23. The fluid conduit 51 is fixed by two spaced-apart support points 57, and the actuator 30 is arranged with its force application point approximately centrally between these two support points 57. The actuator 30 is firmly connected to the outside of the fluid conduit 51.

When the actuator exerts a pulling force or a pushing force on the fluid conduit 51 during operation, this can cause the fluid conduit 51 to move radially between the two support points 57, which can cause a deflection of the fluid conduit 51 in this section. In this way, the compensation volume 41 can be changed and adjusted in order to compensate for a pressure fluctuation. A potential deflection of the fluid conduit 51 when a pushing force is applied by the actuator 30 is indicated by reference numeral 58, for illustrative purposes.

FIG. 8 is a side view showing the basic configuration of yet another compensation element 15 according to the disclosure for actively damping vibrations of a medium 24, which is based on the embodiment of FIG. 7. In contrast to the embodiment of FIG. 7, the side of the fluid conduit 51 opposite to the side on which the actuator 30 engages is fixed. In the embodiment, a plurality of support points 57 are provided for this purpose.

A pushing force exerted by the actuator 30 will enable to move the wall of the fluid conduit 51 on the side facing the actuator 30 towards the opposing wall of the fluid conduit 51, so that the compensation volume 41 can also be decreased. In this embodiment, a higher pushing force will be required by the actuator 30 compared to the aforementioned embodiment which only has two support points 57. A potential deflection of the fluid conduit 51 when a pushing force is applied by the actuator 30 is indicated by reference numeral 59, for illustrative purposes.

In these embodiments of the compensation element 13, 14, and 15, a certain flexibility or resiliency of the fluid conduit 51 should be ensured.

FIG. 9 is a side view showing the basic configuration of yet another compensation element 16 according to the disclosure for actively damping vibrations of a medium 24, in which the hollow body is already provided by the fluid conduit 51, and in which the volume change occurs along the longitudinal extension of the fluid conduit 51. In this embodiment of the disclosure, the fluid conduit 51 is designed so as to be flexible along its longitudinal extension.

For this purpose, a bellows 60 is provided such that an axial change in the length of the fluid conduit 51 is made possible. The actuator 30 is arranged parallel to the axis for this purpose, and is able to cause a longitudinal change in the fluid conduit 51 within the range of the bellows 60 by respective tensile or compressive forces, which can also cause a change in the volume of the compensation volume 41.

The fluid conduit may generally be made of plastics material and may also include elastomers, for example.

For applications that require contact with aggressive or corrosive fluids, such as ultra-pure water, and/or that operate in a vacuum or deep vacuum, special materials and/or coatings or protective layers that are resistant to the fluids are available.

In the case of aggressive or corrosive fluids such as low-salt water, pure water, or in particular ultra-pure water, suitable anti-corrosion coatings are considered, for example based on or comprising tantalum, Inconel, molybdenum, or combinations thereof. PVD coatings are also conceivable, for example. Metallic materials including stainless steel or high-grade steel may also be suitable for the fluid conduit.

Certain plastics materials, for example those that are suitable for use in vacuum, can also constitute useful materials, including PVDF-HP, ECTFE, for example, or even ceramic materials such as SiC.

In a further aspect of the disclosure, the disclosure also encompasses a method for actively damping vibrations of a medium 24, in particular a fluid, comprising the steps of:
providing a compensation element 1, 10, 11, 12, 13, 14, 15, 16;
capturing the total pressure of a medium 24 in a fluid conduit 51, 52, 53 using a pressure sensor 61, 62, 63, 70;
determining the inlet side pressure difference ΔPᵢₙ to a predefined pressure P;
calculating an input value for an electrical parameter, in particular for the electrical voltage, for an actuator 30, and transmitting the input value to the actuator 30;
using the actuator 30 to change the compensation volume 41 on the basis of the input value to decrease or increase the compensation volume 41 in such a way that the pressure difference can be compensated for by the change in volume.

Also encompassed, in a further aspect of the disclosure, is a system 100 for actively damping vibrations of a viscous medium 24, in particular a fluid, which system is configured for carrying out a method for actively damping vibrations of a medium 24, in particular a fluid, as described above.

The system 100 comprises a compensation element 1. FIG. 4 shows an embodiment of such a system 100 for actively damping vibrations of a viscous medium, which comprises a compensation element 11 according to the disclosure merely by way of example, while other compensation elements 10, 12, 13, 14, 15, 16 may likewise be used instead of the compensation element 11.

System 100 comprises a fluid conduit 51, 52 as a supply line for a machine 50, installation or equipment merely sketched as an example, which is completely filled with a medium 24, in this example with demineralized water for a cooling circuit. During operation, a total pressure of, for example, 1 Pa, 100 Pa, 1 kPa, 10 kPa, or even 100 kPa can be set in the system 100.

Also shown in FIG. 4 is a fluid conduit 53 which leads away from the machine 50. The flow direction is indicated by reference numeral 55.

The compensation element allows to ensure that a pressure fluctuation in this system 100 during operation can be +/−10 mPa or less, preferably +/−5 mPa or less, most preferably +/−5 mPa or less.

For the embodiment of a system 100 as shown in FIG. 4 for actively damping vibrations of a medium using a compensation element, a flow rate of nominally 2 L/min is intended, and a hose with an inner diameter of 8 mm is used here. Nominal pressure is 1.3 bar. The compensation volume is provided with a stroke surface area 33 of 25 mm², which can be moved by +5 μm by the actuator 30. This allows, for example, to compensate for a pressure disturbance in a range of approximately 50 to 150 Pa, for example 100 Pa, at 3 Hz.

At a frequency of 30 Hz, for example, pressure surges of about 1000 Pa can be compensated for with a similar stroke movement. This is already sufficient to reduce pressure fluctuations in many demanding applications. It will be appreciated that the stroke surface area and/or the stroke movement can be adapted accordingly in order to be able to operate the compensation element 1 with other operating parameters and to adapt it to the available installation space or the selected drive technology.

The disclosure thus makes it possible to be used on or with machines 50, installations or other equipment which are highly sensitive to pressure fluctuations and which need to be cooled, for example, such as in the semiconductor industry sector.

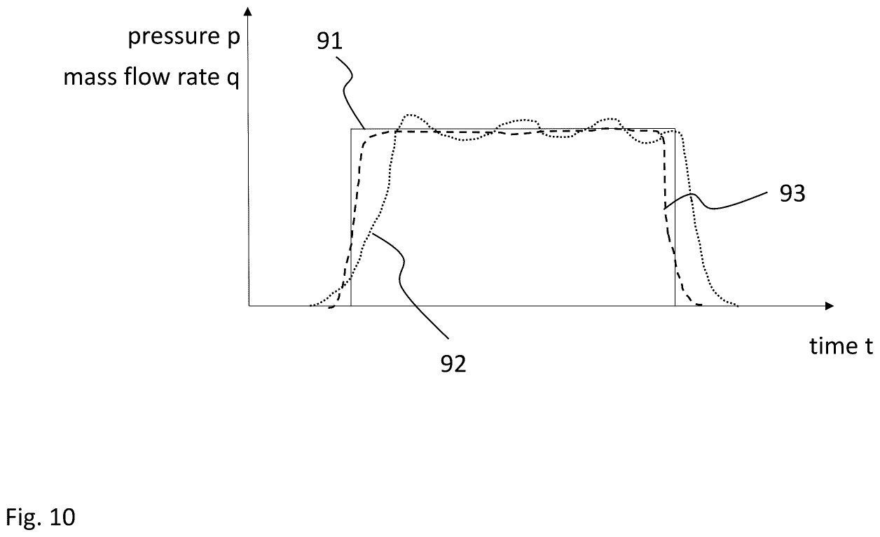

FIG. 10 shows a comparison for the response behavior of the control according to the disclosure by way of a simple example.

Reference numeral 91 indicates a desired pressure change over time t.

Reference numeral 92 indicates the response behavior of a prior art mass flow controller (MFC). Over time, rather significant deviations from the setpoint value for the pressure p are evident in some instances, and as an alternative, a mass flow rate q can also be assumed here.

Finally, reference numeral 93 indicates the response behavior that can be achieved using the compensation element 1, 10, 11, 12, 13, 14, 15, 16.

What is evident here is the higher dynamics in the control, i.e. a faster reaching of the setpoint value, as well as a lower deviation from the setpoint value over time.

Thus, a desired mass flow rate of a fluid can be adjusted very quickly and precisely, delayed overshooting is significantly reduced.

1. A compensation element for actively damping vibrations of a medium, comprising:
a hollow body having an internal volume, with a compensation volume being formed in the internal volume, with the hollow body further having at least two openings which connect the compensation volume to the environment; and
at least one actuator which can increase or decrease the compensation volume during operation.

2. The compensation element of claim 1, wherein the medium comprises a fluid in gaseous or liquid form, in particular a liquid fluid having a compression modulus under normal pressure at 0.1 MPa and at a temperature of 10° C. of at least 1.0·10⁹ Pa.

3. The compensation element of claim 2, wherein the fluid comprises aggressive or corrosive gases or liquids, in particular a demineralized water having a conductivity of 1-50 μS/cm.

4. The compensation element of claim 1, wherein the medium is accommodated in a fluid conduit, in a piping system, in a hydraulic line, in a pressure line, or in a container or vessel.

5. The compensation element of claim 4, wherein the openings of the compensation element are connected to the fluid conduit in a force-fitting and/or form-fitting manner, wherein the medium can pass or flow from the fluid conduit into the compensation volume during operation.

6. The compensation element of claim 4, wherein the compensation element is separable from the fluid conduit in a non-destructive manner.

7. The compensation element of claim 4, wherein the compensation element can be connected or is directly connected to a machine, an installation component or equipment, wherein the connection is adapted so as to be separable in a non-destructive manner.

8. The compensation element of claim 4, wherein the connection between the compensation element and the fluid conduit is fluid-tight.

9. The compensation element of claim 4, wherein a first opening of the hollow body is connected to at least a portion of the fluid conduit which is exposed to pressure fluctuation, and/or wherein a second opening of the hollow body is connected to the fluid conduit.

10. The compensation element of claim 1, wherein the at least one actuator is arranged outside the internal volume of the hollow body.

11. The compensation element of claim 1, wherein the at least one actuator is arranged inside the internal volume of the hollow body.

12. The compensation element of claim 4, wherein, during operation, the at least one actuator is able to change a size of the compensation volume by a stroke movement, as a function of pressure fluctuations in the fluid conduit.

13. The compensation element of claim 1, wherein the at least one actuator comprises an actuator based on a magnetic principle, piezo principle, or electrostatic principle, or a combination thereof.

14. The compensation element of claim 1, wherein the at least one actuator comprises an actuator including a piezoelectric material, wherein the actuator is protected against aggressive or corrosive fluids, preferably by a coating.

15. The compensation element of claim 1, wherein the internal volume is divided into two partial volumes by a flexible diaphragm, whereby an additional balancing volume is defined in addition to the compensation volume.

16. The compensation element of claim 1, further comprising a pressure body is movable by the at least one actuator to thereby act on the flexible diaphragm.

17. The compensation element of claim 4, further comprising at least one pressure sensor for determining a total pressure, inside at least one opening of the hollow body, and/or inside the fluid conduit.

18. The compensation element of claim 1, wherein at least one force sensor is provided, which measures the force acting on the actuator by the compensation element.

19. The compensation element of claim 1, wherein control of the compensation element is accomplished according to a feedback control procedure or according to feed forward procedure involving feedforwarding of a disturbance variable.

20. The compensation element of claim 1, wherein a flow rate of the medium is taken into account for controlling the compensation element.

21. The compensation element of claim 1, wherein the hollow body has an internal volume is provided by a fluid conduit.

22. The compensation element of claim 21, wherein a change in volume is caused by the at least one actuator through a substantially radial deflection of the fluid conduit as a whole or by deflection of only one wall of the fluid conduit during operation.

23. The compensation element of claim 22, wherein the fluid conduit is adapted so as to be flexible along its longitudinal extension, and the change in volume is caused by an axial change in length of the fluid conduit.

24. A method for actively damping vibrations of a medium comprising the steps of:
providing a compensation element;
capturing a total pressure of a medium in a fluid conduit using a pressure sensor;
determining an inlet side pressure difference ΔPᵢₙ to a predefined pressure P;
calculating an input value for an electrical parameter, in particular for an electrical voltage, for an actuator, and transmitting the input value to the actuator; and
using the actuator to change a compensation volume on a basis of the input value to decrease or increase the compensation volume in such a way that the pressure difference can be compensated for by the change in volume.

25. A system for actively damping vibrations of a viscous medium, configured for performing a method according to the preceding claim.

26. A system for controlling a mass flow rate of a medium, comprising a compensation element according to claim 1.

27. The system of claim 26, wherein the system is used for dosing fluids or for mixing fluids.

28. A machine, installation or other equipment, comprising a compensation element according to claim 1.
